(19) United States
(12) Patent Application Publication
(10) Pub. No.: US 2020/0327576 A1
(43) Pub. Date: Oct. 15, 2020

(54) SYSTEMS AND METHODS FOR IMPLEMENTING TRANSACTIONAL PROMOTIONS

(71) Applicant: Synchrony Bank, Stamford, CT (US)

(72) Inventors: Theresa Kraus, Stamford, CT (US); Nathan Feighner, Stamford, CT (US); Craig Urbansky, Stamford, CT (US); Gretakae Northern, Stamford, CT (US); William Schroeder, Stamford, CT (US); Jay Neidermeyer, Stamford, CT (US); Stephen Roe, Stamford, CT (US); Kristine Hanson, Stamford, CT (US)

(21) Appl. No.: 16/848,340

(22) Filed: Apr. 14, 2020

Related U.S. Application Data
(60) Provisional application No. 62/834,103, filed on Apr. 15, 2019.

(51) Int. Cl. G06Q 30/02; G06Q 20/40

(52) U.S. Cl. CPC G06Q 30/0224; G06Q 20/4016; G06Q 30/0225

(57) ABSTRACT

Examples described herein include systems, methods, instructions, and other implementations of transactional promotions. One embodiment includes receipt of an authorization request message for a transaction associated with an account number. The authorization request message includes a merchant category code and does not include promotion information. A determination is then made that the transaction is eligible for a promotion based on the merchant category code. The promotion is then automatically applied to the transaction at the account number, and an authorization response message is then generated authorizing the transaction.

### CROSS-REFERENCES TO RELATED APPLICATIONS

This application claims the benefit of U.S. Provisional Application No. 62/834,103, filed Apr. 15, 2019, which is hereby incorporated by reference, in its entirety for all purposes.

### FIELD

The present disclosure relates generally to transactions. In one example, the systems and methods described herein may be used to implement promotions in a variety of transactional contexts.

### BACKGROUND

Promotions are important for merchants to implement in order to encourage customers to spend money at their establishments. Promotions may come in a variety of forms. For example, a promotion may be a discount or a free gift with purchase. Promotions may also be made in conjunction with issuers. For example, a promotion may be a financing incentive for use with a particular credit card, such as no interest financing or rewards.

### SUMMARY

Disclosed embodiments may provide a framework to implement transactional promotions automatically without merchant participation in the process. A cardholder utilizing a network card may receive a financing promotion for purchases over a certain dollar threshold at certain locations and within allowable merchant category codes for purchase. Embodiments provide a significant improvement over traditional methods where the merchant was required to enter a promotional code along with the purchase information for the system to process the authorization and apply the promotion.

In some implementations, transactional promotions for out of network merchants which are applied automatically without participation of the out of network merchants can be performed alongside transactional promotions for in network merchants, where the in network merchants participate in the promotion process.

According to some embodiments, a computer-implemented method is provided. The method comprises receiving an authorization request message for a transaction associated with an account number, wherein the authorization request message includes a merchant category code, and wherein the authorization request message does not include promotion information; determining that the transaction is eligible for a promotion based on the merchant category code; automatically applying the promotion to the transaction at the account number; and generating an authorization response message authorizing the transaction.

According to some embodiments, a computer-program product is provided. The computer-program product is tangibly embodied in a non-transitory machine-readable storage medium, including instructions that, when executed by one or more processors, cause the one or more processors to perform the steps of the above method.

According to some embodiments, a system is provided. The system comprises one or more processors, and one or more non-transitory machine-readable storage media containing instructions that, when executed on the one or more processors, cause the one or more processors to perform operations including the steps of the above method.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

The present disclosure is described in conjunction with the appended figures:

FIG. 1 depicts aspects of a system that can be used with implementations of transactional promotions in accordance with examples described herein.

FIG. 2 depicts aspects of operation of a payment communication system in accordance with some examples.

FIG. 3 depicts aspects of operation of a payment communication system in accordance with some examples.

FIG. 4 depicts aspects of operation of a payment communication system in accordance with some examples.

FIG. 5 is a flow diagram illustrating an example method in accordance with some embodiments.

FIG. 6 depicts aspects of a system that can be used with implementations of transactional promotions in accordance with some examples described herein.

FIG. 7 depicts aspects of operation of a payment communication system in accordance with some examples.

FIG. 8 depicts aspects of operation of a payment communication system in accordance with some examples.

FIG. 9 depicts aspects of operation of a payment communication system in accordance with some examples.

FIG. 10 is a flow diagram illustrating an example method in accordance with some embodiments.

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides examples of embodiment(s) only and is not intended to limit the scope, applicability or configuration of the disclosure. Rather, the ensuing description of the examples of embodiment(s) will provide those skilled in the art with an enabling description for implementing examples of embodiment. It is understood that various changes can be made in the function and arrangement of elements without departing from the spirit and scope as set forth in the appended claims.

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to implement transactional promotions automatically without merchant participation in the process. In previous systems, merchant participation was part of such promotional transactions, with the merchant providing promotional codes as part of such a promotional transaction. In some examples, a cardholder utilizing a network card may receive a financing promotion for purchases over a certain dollar threshold at certain locations and within allowable merchant category codes (MCCs) for purchase. Embodiments provide a significant improvement over traditional methods where the merchant was required to enter a promotional code along with the purchase information for the system to process the authorization and apply the promotion.

Additionally, an authorization system in some examples can include both systems for implementing transactional promotions without merchant participation as described above, as well as systems for implementing transactions with transactional promotions. In some examples, merchants in a network have merchant systems (e.g. merchant associated computing devices) that are part of a network associated with a payment card. Such merchant systems can have associated devices (e.g. point of sale (POS) terminals or salesperson terminals) configured to accept promotional codes and to generate notices of promotions at the point of sale. Such systems can thus provide special communications (e.g. printed notice of promotional terms) directly to a customer after a payment is authorized by an authorization system of a payment communication network. For merchants not part of such a network and not configured to provide such notices, an alternate promotion system can be implemented that operates without involvement of the merchant system. Such examples further improve the operation of a payment communication network by enabling functionality for a broader range of merchant systems than those limited to specially configured in network merchant systems. Such improvements can include a communication path for providing notice of promotional terms that occurs outside of the payment communication network before the authorization occurs, so that the customer is informed of promotional terms prior to any transaction. In some embodiments, such paths can be implemented via communication with a customer device, or by communications that accompany a customer credit card as it is delivered to a customer. By enabling both in network and out of network promotions, examples described herein improve the operations of the payment communication network and devices operating within the payment communication network.

In some embodiments, the system coding for promotions may be a new custom setting to follow the customer account with promotions through an authorization system (e.g. mainframe systems or networked computing devices operating as part of a payment communication network that includes promotion systems integrated with payment authorization). In some examples, promotions within a payment communication system may be set up at the cardholder account system hierarchy level. Based on the variable provided (e.g. system, transaction amount, and MCC) to the authorization system, the authorization system (e.g. mainframe or other computing devices implementing operations for authorization) may utilize promotional transaction tables to apply a promotion to the cardholder account for that individual sale. For example, the promotion can provide six months with deferred interest. Other promotions can provide initial promotional interest rates, or other such promotional benefits such as promotional financing offers, rewards such as cash back or statement credits, or the like.

Additional details of various example implementations for implementing transactional promotions within a payment communication network are described below.

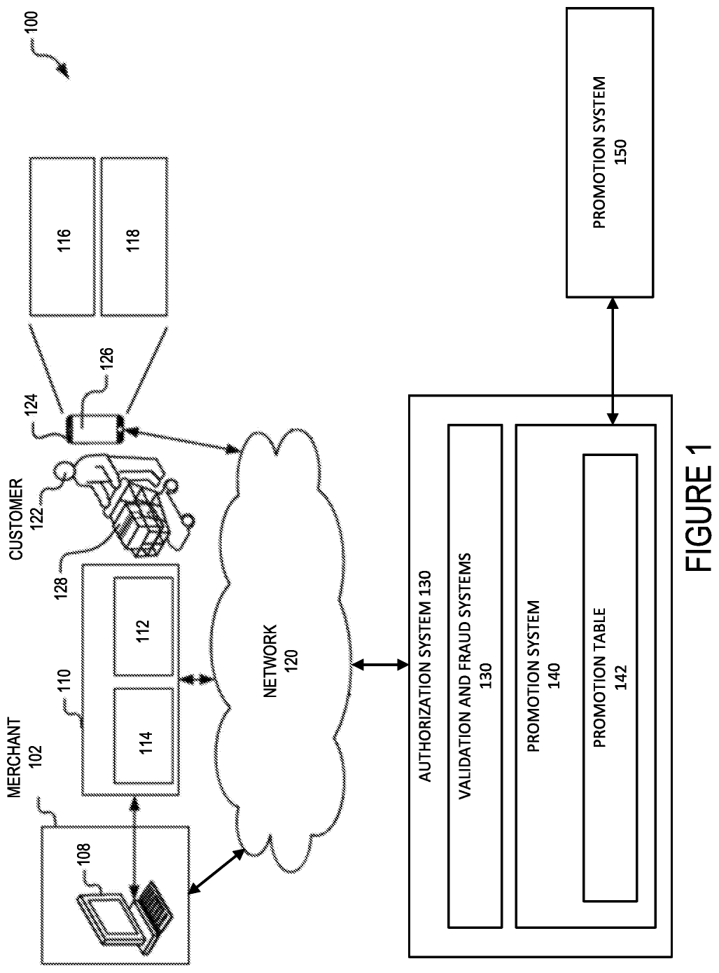

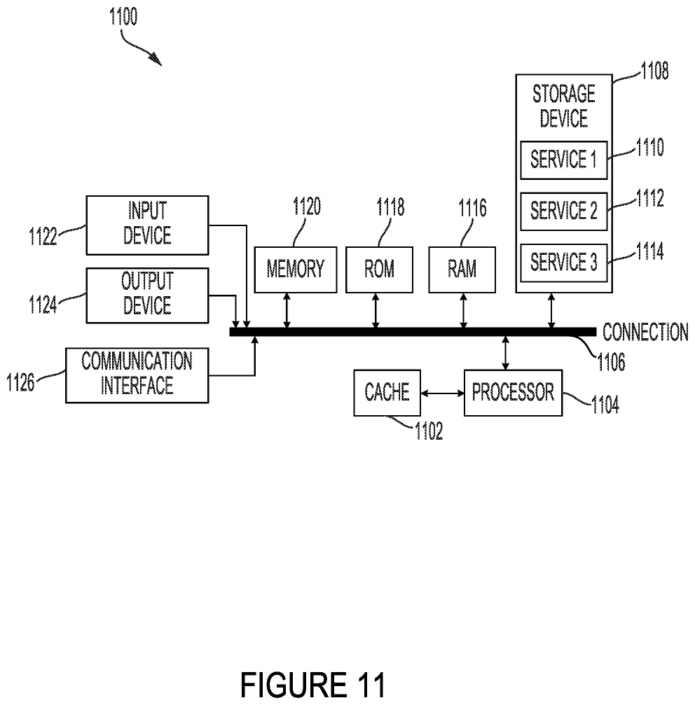

FIG. 1 is a block diagram of a payment communication network 100 in which network data management and transactional promotion communications are performed in accordance with some examples. The example payment communication network 100 includes a merchant 102 implementing a merchant system 108, which can be one or more networked computing devices that can be networked both with merchant device 110 (e.g. a checkout register, point of sale (POS) devices, or any other such device) and a network 120. The POS device(s) 110 can include a scanner 112 (e.g. any input devices for accepting information associated with a transaction) and a display 114. Other implementations can include a credit card scanner or other payment input, a keypad, or other such elements. Additional examples of an originating merchant device 110 can be a tablet device, a smartphone, a laptop computer, or any other such device that can be accessed by a customer, either directly, or through an employee of the retailer. The merchant system 108 may be directly connected or connected by one or more networks 120 to the merchant device 110. The merchant system 108 and the merchant device 110 may each be implemented by one or more computing devices, which may each be implemented as a computing device with architecture 1100 described below and illustrated in FIG. 11.

Referring to FIG. 1, the merchant device 110 is configured to perform operations associated with a purchase transaction for a customer 122 and a product 128 associated with an MCC. In some examples, a customer can a customer device 124 (e.g., a cellular telephone, a chip card, a credit card, etc.) associated with a customer account. Some examples of a client device 124 can include a display device 126 (e.g., a conventional touch screen) which can include a payment interface 116 or device payment systems 118. Other implementations can operate with a client device 124 that does not include a display device (e.g. a credit card).

A customer 122 may purchase one or more products 128 using the merchant device 110 using a customer device 124, which can include a credit card with a magnetic stripe, a credit card with an embedded microchip, a contactless card, a phone application or mobile payment device (e.g. integrated with a smartphone), or other such customer devices 124. When the customer interacts with the merchant device 110 to make a payment, the merchant device is configured for a payment channel based on the particular customer device 124 used for a payment. The merchant device 110 generates and communications an authorization request message. For certain authorization request messages operating outside of a promotion program configured for a merchant, the authorization request message can include a MCC or other such category code with no promotion details. The authorization request message can be routed to an authorization system, with the authorization system processing the authorization request message to generate an authorization response, and to apply promotion details that follow the customer based on the category code independent of any merchant promotion. In such examples, the authorization system can identify the promotion, and response with an authorization response message approving the transaction but not including promotion details. Any communications regarding the promotion details, since they are independent of the merchant, can be communicated with a settlement statement provided to a customer or customer device 124 (e.g. for smartphone or computing device customer devices).

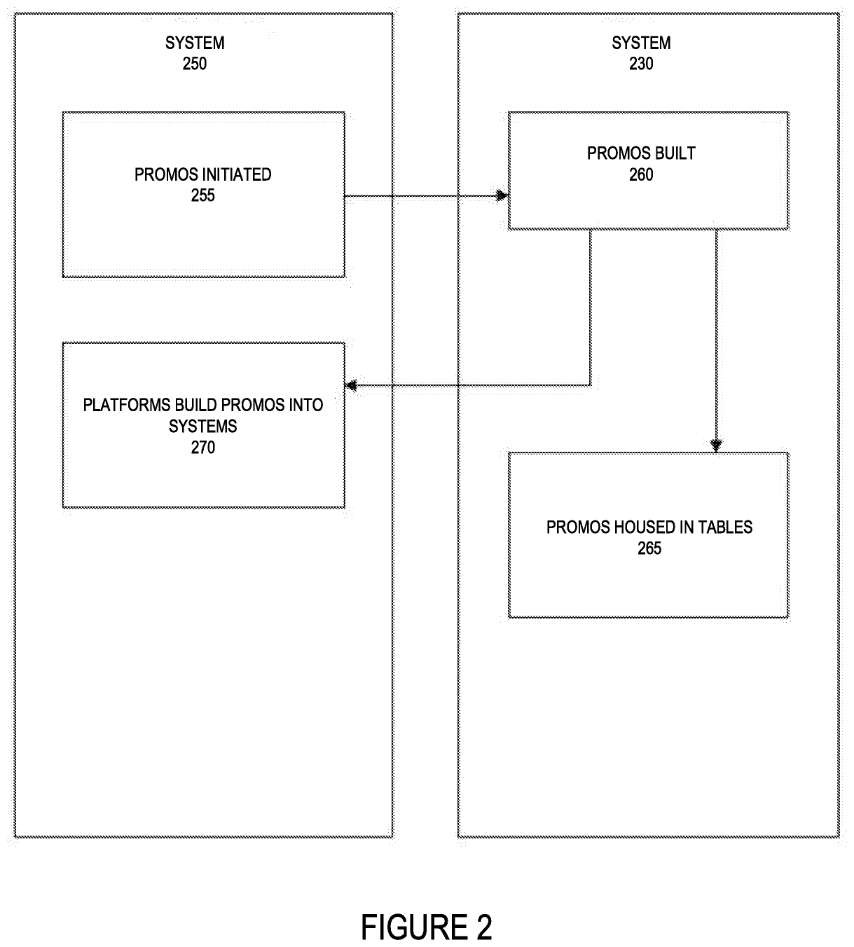

An authorization entity can operate one or more authorization computing devices as part of an authorization system 130 configured as part of a payment communication network 100. The authorization system 130 can include various sub-systems or component functions implemented on processors of the authorization system to enable authorization of payment transactions between customer 122 and merchant 102. The authorization system 130 can include validation and fraud systems 130, as well as a promotion system 140. Validation and fraud systems can include computing systems for validating card numbers from customer device 124 to confirm that credit or payment funds are available to match the purchase amount associated with a transaction being authorized. Additional fraud analysis operations can analyze and process information associated with any aspect of a transaction to approve or deny an authorization request. When an authorization request results in an approval, promotion system 140 can, in accordance with some examples, confirm that a merchant and MCC are associated with a promotion using a promotion table stored in authorization system 130. This information can be provided by an independent promotion system 150, which is described in more detail in various examples below. In some examples, the promotion system is associated with a card issuer or other aspects of a payment communication system, and can be applied to the transaction at the account number by the authorization system, with such information stored in a database, either at authorization system 130 or in another system associated with the card issuer. In examples where a promotion table 142 is used to identify and apply a promotion independent of a merchant 102, a communication confirming the promotion can be generated from data stored with promotion system 150 or another issuer system, and communicated directly from such a system (e.g. promotion system 150) to customer 122 outside of the authorization system 130. Examples of various communications between authorization systems, merchant systems, customer devices, and additional systems such as promotion system 150, are described below in FIGS. 2-7.

In addition to the systems described above, an authorization system can in various implementations, include additional systems for security, fraud detection, and other functionalities. Some implementations can include a token service that can act in a number of ways to facilitate secure communications between customer 122 and various other services and devices, including retail computing system 108 and other systems. Tokenization is a process of substituting sensitive data elements with non-sensitive equivalents (e.g. tokens). The token is a reference identifier that can be mapped to the sensitive data via token service. Such a token service can use large random number in combination with other systems, such as timing systems, to limit and secure the use of sensitive data being communicated over networks such as networks 120.

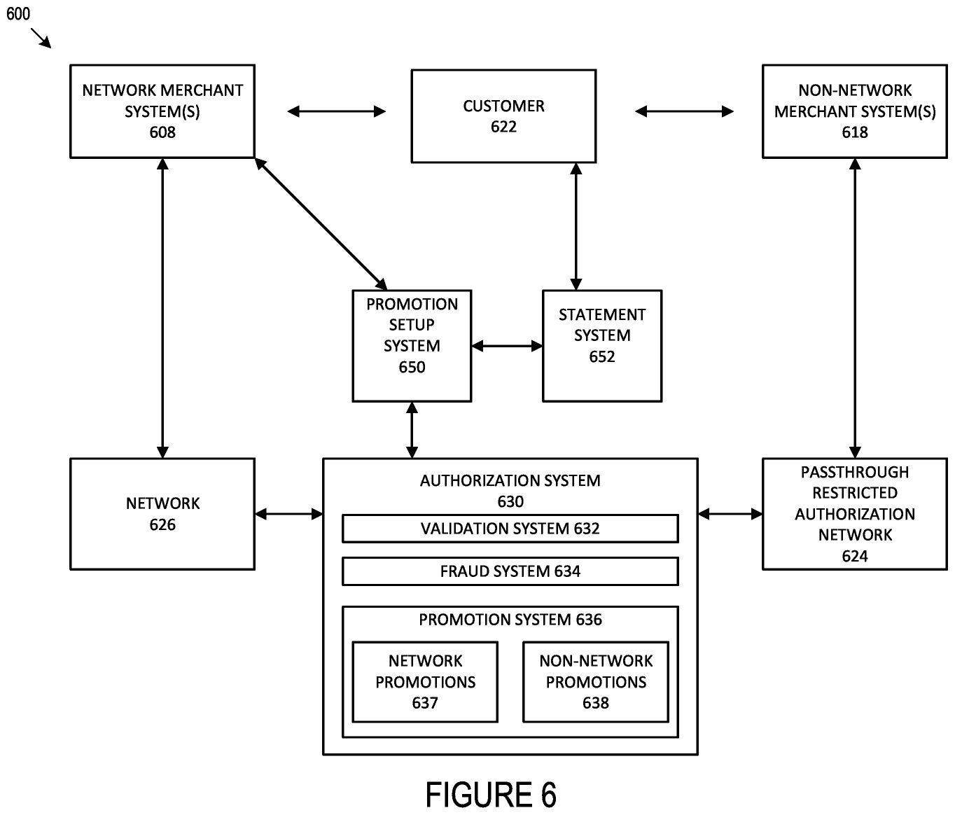

As described above, in some examples, authorization system 130 can be integrated with other systems, such as a credit issuing system and communication channels with a customer 122 outside the authorization channels used to communicate authorization request messages and responses between merchant devices (e.g. merchant device 110) and devices of an authorization system (e.g. authorization system 130. In such a system various additional functionality can be integrated for security and payment systems improves, such as the use of token services as described above. Additionally, while FIG. 1 illustrates communications between various systems and devices, including merchant device 110, merchant system 108, customer device 124, authorization system 130, promotion system 150, and network 120, in additional examples, other aspects of payment communication network 100 can further be altered or include additional or intervening elements, such as multiple customers, customers with shared accounts and devices, additional merchant or retailer systems, subsystems that can operate independently, additional communication channels, or other such structures. FIG. 6 illustrates aspects of some such details for another implementation of a payment communication system, and additional or alternative implementations are also possible in accordance with examples described herein.

FIG. 2 depicts aspects of operations of a payment communication system in accordance with some examples. In particular, FIG. 2 illustrates operations to create transactional promotion data within a payment communication system that can later be used to associated a promotion with a particular transaction (e.g. by comparing transaction values from an authorization request message with promotion data in a table stored in an authorization system such as systems 230 and authorization system 130) without involvement of the merchant, merchant systems, or merchant devices in the promotion other than non-promotion aspects of the authorization for the purchase associated with the transaction. Thus, promotion information is associated with a transaction by matching transaction data with promotion limitations so that a promotion is applied with the transaction data matches the limitations for the promotion. This allows promotions to be applied to a transaction without involvement of the merchant systems, and without promotion information being included in an authorization request message.

The example of FIG. 2 includes two entities involved in building out promotions: system 250 (e.g. a promotion system similar to promotion systems 250 or 650, or applications for a promotion operating within a system); and authorization system 230 (e.g. a system similar to authorization systems 130, 630, or other such systems or mainframes). In the example of FIG. 2, the various systems perform operations to generate promotional data and place the promotional data for use during authorization operations within a payment communication system. As illustrated by FIG. 2, at step 455, promotions are initiated in system 250 (e.g. by a system dedicated to managing and initiating promotions). The promotions of FIG. 2 are structured for application to transactions without the involvement of merchant systems, such that the promotion follows a customer. Such promotions can include limits and triggers input to system 250 by sales groups associated with issuing credit to a customer and organizing the devices and data for such credit (e.g. using customer devices such as a credit card or payment application on a smartphone). Such limits as part of an initiated promotion can include identifying MCCs to be associated with a promotion, purchase amounts, or other such limits for a promotion. Various examples of promotions can be triggered based on MCCs, total value of a purchase, time of a purchase, or any other such information. In some examples, the data used to assess whether a transaction is eligible for a promotion is configured to be entirely assessed from transaction values contained in an authorization request message. In other examples, additional data, such as purchase histories associated with a customer or customer account, customer location, customer preferences provided to a system, customer payment history information, or any other such information that can be stored in a database connected to system 230 can be used to determine when a promotion is to be offered for a particular purchase. In some examples, if pricing data is used as part of the promotional data, financing systems can add such data during step 255. After the initial promotional data is organized at promotion system 250, the promotion data is provided to authorization system 230. Authorization system 230 processes the promotion data in step 260 to build promotion tables. In step 265, the promotion tables are stored in memory of system 230 for use in later transactions as described below.

Additionally, in step 270, the built promotional structures are then integrated into platforms operated in conjunction with promotional system 250. This integration can include issuer functionality, such as providing purchase histories, general credit and payment terms, and periodic payment information or billing data to a customer. As part of building such a promotion into a platform using promotion system 250, communications are generated, such as disclosure communications to be sent to a customer with a customer device to be used in making purchase. For example, a credit card that is associated with the promotion initiated in step 255 to be provided to a customer without merchant involvement can have the terms of the promotion integrated with distribution of the credit card to a customer. This platform build notification provides the customer notification of the terms of the promotion, so that the customer will have been notified of the terms of the promotion prior to any transaction automatically having the promotion applied without involvement of the merchant or notification concurrent with the transaction. In another example, if the customer device is a smartphone payment system, the platform build can integrate notice of the terms into a user interface of the smartphone payment system to be distributed to a customer's smartphone prior to the customer making payments. At the end of the steps illustrated by FIG. 2, the platform communications including notification of the promotional terms have been provided to customers with accounts associated with the promotion, and the promotion data to be used by an authorization system in determining whether a promotion is to be applied to a particular transaction are stored in an authorization system as illustrated by system 230 including promotional data stored in tables as described in step 265. This promotion data stored in the system 230 allows application of promotion to a transaction when an authorization request message does not include promotion information.

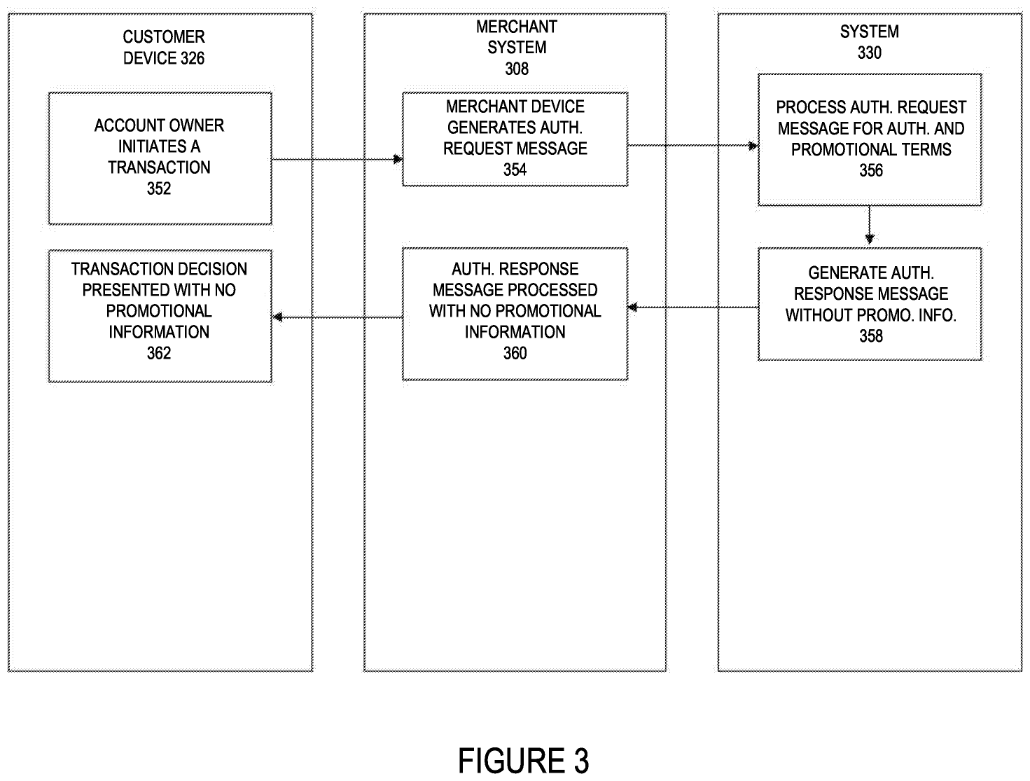

The promotion can then be implemented as part of a transaction without involving merchant devices or systems in any communication or selection of the promotion as illustrated in the example of FIG. 3. FIG. 3 depicts a system diagram for a transaction using a promotion that follows a customer device 326 and does not involve merchant system 308 in the promotion. This system can, for example, use the promotion data and structures put in place as described in FIG. 2. The transaction depicted in FIG. 3 involves three entities: a customer via a customer device 326, a merchant via merchant system 308, and an authorization system 330 (e.g. using an authorization computing device or mainframe within a system such as system 130 or 630). Additional entities may be involved in the transaction according to some embodiments (e.g. additional acquirer or issuer devices, third party systems, etc.)

At step 352, the customer may initiate a purchase or a transaction with a merchant using a customer device 326 (e.g. a credit card, a payment application on a customer device, etc.) As described above, the merchant system in some implementations is not configured to manage promotions. This lack of functionality can be because of merchant device compatibility, merchants not being part of a particular program, or other such configurations. In some embodiments, the purchase may be made at a location outside of a particular issuer program. While a customer device 326 can be associated with a network having particular promotions selectable by an in network merchant, the customer device 326 can still be used with a merchant system 308 not part of such a network. When the customer device 326 is used to provide data to merchant system 308 (e.g. by swiping a credit card, providing data from a chip card, or entry of a number printed on a customer device into a merchant POS device) there may thus be no promotional choices due to the limitations of the merchant system 308. The merchant system 308 may run the transaction as they would any other transaction with no promotion data, so that the promotion is not be applied by merchant. In addition, there may be no promotional fee to merchants outside of the interchange for that transaction. Instead, the merchant system 308 simply accepts data to generate an authorization request message as part of step 354 and the authorization request message for the transaction is sent to system 330. The authorization request message can include a MCC associated with the promotion in system 330. In some implementations, the authorization request message can include additional transaction values that can be used by system 330, including a vendor network indicator (e.g. a merchant identifier), a purchase amount, an account number for the customer from customer device 326, or any other such information.

The authorization request message can be routed to system 330 in a variety of ways. In some implementations, the authorization request message is sent via a restricted authorization network as part of a payment communication network (e.g. payment communication network 100 or payment communication network 600). As described above, the promotion implemented in system 330 can be configured and applied without participation of a merchant, for example when a program includes in network merchants, and the current merchant is not in the network. In such systems, such as the payment communication network 600, a standard network can be used for in network merchants (e.g. network 626), and a restricted authorization network (e.g. passthrough restricted authorization network 624) can be used for out of network merchants. A single authorization system can accept authorization request messages from both types of merchants, but via different network paths. Additional details of such networks and systems are described below with respect to FIGS. 6-9.

At step 356, the authorization request message is received at system 330 and processed for authorization and for promotional terms. This processing can include parsing data of the authorization request message for particular transaction values. The processing for authorization can include validation of account values, expiration dates, card verification values, and other such data. This processing can also involve checking against fraud rules. Such fraud rules can involve a comparison of historical purchases (e.g. purchasing patterns or purchase value compared with the current purchase) or general purchase patterns (e.g. a purchase data compared against general risk associated with similar purchases), or locations against data from the authorization request message (e.g. a location of the merchant or merchant device 326). In various implementations, other such fraud checks can be used, though in some examples, a response time available for processing and generating an authorization response message is limited by standard timings.

If the transaction is authorized, the identified transaction values can be compared with authorization and promotional term variables stored in system 330, including promotional variables stored in a promotion table of system 330. In some examples, the processing of step 356 can involve multiple tables in system 330. In one example, a consumer account table includes codes to assist system 330 in associating an appropriate promotion with a consumer based on transaction values from an authorization request message. Based on the transaction values and variables for the promotion, a promotion transaction table within system 330 is used to apply the details of promotions to a cardholder account. The application of the promotion to the transaction at the account number for the customer can include processing at system 330 as well as communications to an addition system (e.g. an issuer system) so that communications with the customer, including notices of payment due dates and current balances, can accurately represent the values associated with the purchase based on the promotion as applied by system 330 using the promotional transaction tables. In some implementations, all information for identifying the promotional terms and automatically applying the promotional terms are contained within the authorization request message and a table of promotion data within system 330. In other implementations post-processing using data from multiple transactions can be used to bundle data from multiple transactions and apply promotional terms to some or all of the bundled transactions. For example, a bundled threshold can be used to apply promotional terms to transactions that occur after a threshold total value of all transactions exceeds a threshold amount. In other examples, the promotional terms can be applied to all transactions that occur in the time period once the bundled threshold amount is exceeded for all transactions in the time period. In other examples, other such post-processing can be used to apply promotional terms to transactions associated with system 330, with notice of the terms provided prior to the transactions occurring (e.g. as described below using a statement system 652 and promotion setup system 650).

At step 358, an authorization response message is generated. The response is generated independent of any promotion, as the promotion is independent of the merchant system 308. If the transaction is approved (e.g. authorized) the authorization response message is generated without promotional information because of the configuration of merchant system as described above. If the transaction is not approved, the promotion is irrelevant as there is no purchase to apply the promotion to. The response message is sent to merchant system 308, and in step 360, the merchant system 308, the authorization response message is received and processed by merchant system 308 with no promotional information. As described above, since the promotion follows the customer and is not tied to merchant system 308, the promotion data is not used at the merchant system 308. Similarly, in step 362, a transaction decision based on the authorization response message is then presented to the customer with no promotional information. As described above, the terms of the promotion, including when the promotion will be applied, are communicated to the customer through a platform build prior to the transaction (e.g. step 270 of FIG. 2). The promotion is thus automatically applied by system 230 and any related system without concurrent notification to the customer. While other transactions with in network merchants can include such concurrent notification with involvement of the merchant, the promotional transaction of FIG. 3 does not includes such communications. As described above, improvement of the operation of a payment communication network is thus enabled for certain transactions that would not be possible in prior systems. Additionally, the operations of individual devices are improved with enablement of new transactions, and application of promotions to transactions without the using of processing resources or communication resources at the merchant and customer level once the transaction is authorized.

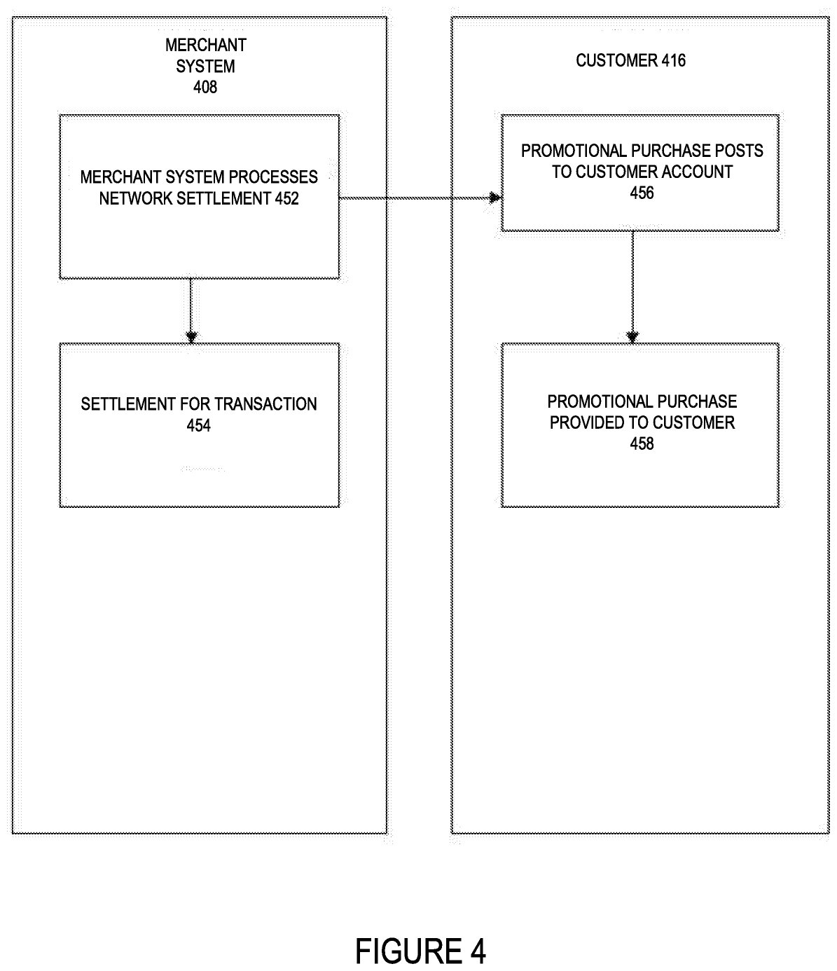

The post transaction notification is instead managed through a settlement network as illustrated by FIG. 4. FIG. 4 depicts a system diagram for settlement and statement operations associated with a transaction performed in accordance with the examples illustrated in FIGS. 2 and 3 according to some embodiments. Settlement according to this embodiment may involve at least two entities: merchant system 408 and customer 416. In some implementations, additional entities can be involves in the settlement process.

At step 452, the merchant system 408 can process a network settlement. At step 454, settlement may occur for the transaction minus interchange fees as associated with an account of the customer 416 that initiated a transaction (e.g. in step 352). In some embodiments, settlement may occur within 24-48 hours. In other implementations, various different limitations or procedures can be implemented for the settlement. In the examples described herein, notification to the customer of the promotion is not provided as part of the authorization process, but is provided as part of terms associated with an account, indicating the circumstances in which the promotion can be applied, and is then later communication during or following settlement. In step 456 the promotional purchase may post to the customer 416 account with a specific promotional term. This notice of the promotional terms as applied to a particular transaction can be communicated to a client device, or via any mechanism selected by customer 416 and available from a system associated with the authorization system that initiated application of the promotion. At step 458, the promotional purchase may appear to the customer 416 in a user interface of a customer device or via any communication channel associated with a customer 416 account.

Thus, as described above, examples implement promotional transactions with improved device and network performance due to limiting merchant system involvement with the promotion and providing functionality for merchants not configured for merchant specific promotions or network based promotions. In some such implementations, a single authorization system can process different authorization requests from a single customer device via two different routes, with in network routes and merchants processed with merchant involvement in promotions (e.g. authorization request messages including promotion data) and out of network merchants and paths not involved in promotions (e.g. authorization request messages not including promotion data) as described above in FIGS. 2-4.

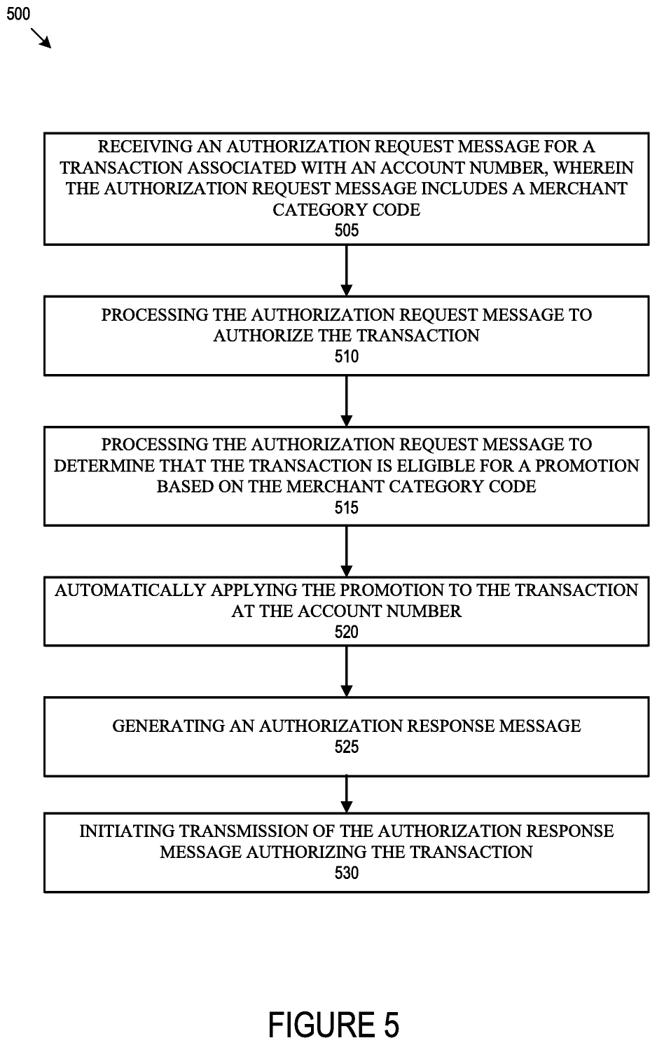

FIG. 5 is a flow diagram illustrating an example method 500 in accordance with some embodiments. Method 500 can be performed by one or more processors of a server computer or server system as part of an authorization system (e.g. authorization systems 130, 230, 330, etc.). Method 500 can, in some examples, be implemented as computer readable instructions that, when executed by processing circuitry of a device, cause the device to perform steps of method 500.

Method 500 includes step 505 to receive an authorization request message for a transaction associated with an account number, wherein the authorization request message includes a category code. In some examples, the authorization request message is received via a restricted authorization network that operates independently of the authorization system, with the authorization system configured to apply promotions to a transaction with operations that allow the promotion to be applied without interaction of the merchant or restricted authorization network with promotion data (e.g. as these systems may not be configured to process such promotion data). In other examples, any other such systems can be used to provide the authorization request message as part of a promotional transaction configured with a promotion to follow a customer without certain merchant systems interacting with the promotion data. Other examples can include systems where certain merchant systems interact with certain promotional data, and other merchant systems operate without interacting with promotional data to allow promotions (e.g. using different promotional data) to be applied to transactions with the other merchant systems. The authorization request message includes a MCC, and can include additional transaction data such as a purchase amount, a merchant identifier, a vendor network identifier, an account number associated with the customer and the purchase transaction, or other such information.

Step 510 then processes the authorization request message to authorize the transaction. Step 510 can include various processes in different implementations, including validation systems for confirming the account associated with the customer, the merchant identity, or the product or service involved with the purchase. In one implementation, transaction authorization involves processing a merchant identifier and the account number from the authorization request message, analyzing one or more transaction values associated with the authorization request message using a set of fraud rules, and authorizing the transaction based on the set of fraud rules, the merchant identifier, and the account number. Such rules can involve history data for a customer, or risk data that is either tied to the customer account or generalized for risk based on similar transactions (e.g. location, merchant, purchase type, transaction patterns, or other such data).

Step 515 processes the authorization request message to determine that the transaction is eligible for a promotion based on the category code. In some implementations, this processing can include analyzing a merchant identifier to confirm that the merchant does not belong to a merchant group associated with the account number. Promotions for out of network (e.g. non-group merchants) can then be accessed. In various implementations, transaction eligibility determination can include additional steps to identify one or more transaction values from the authorization request message, where the one or more transaction values follow a consumer associated with the authorization request and the transaction is further determined as eligible based on the one or more transaction values. For example, transactions above a certain threshold amount can have an automatic promotion (e.g. a specific interest rate or an interest deferral period) applied to the transaction at the account number associated with the customer. In some implementations, transactions for an amount below the threshold can be applied to the account under standard terms (e.g. with no promotions), or can have a different promotion. In additional implementations, any such thresholds or triggers for automatic application of a promotion to a transaction can be used. Such threshold and triggers can be implemented for purchases occurring within a particular time period, such as a certain month of the year or a certain amount of time since a triggering event (e.g. opening of the account associated with the account number). Such thresholds and triggers can also include ranges, such that a promotion is applied to a value above a first threshold and below a second threshold. In some implementations, this can be based on data that is not from the authorization request message. For example, if a certain total purchase amount for multiple purchases is met, data from previous transactions can be used to trigger automatic application of the promotion to a current transaction associated with the authorization request message. Such additional data can be stored in an authorization system, or accessed from a networked system or database.

Some implementations of step 515 involve the use of a promotion table. One example implementation of operations for such a step involve accessing data for a promotion table (e.g. data stored in an authorization system as part of a previous operation such as step 265). An associated entry in the promotional table is identified associated with the purchase amount and the category code (e.g. where the data from the authorization request message matches the MCC and amount values identified as associated with a particular promotion in the promotion table. The promotion is then identified from the associated entry in the promotion table.

In some implementations, an account number will have an associated flag indicating that the customer was provided a notification of the promotion terms more than a threshold time prior to the transaction data. This threshold time can, for example, be 60 days, 30 days, or any other such threshold time period. Such a threshold time allows sufficient time for the system to provide notice of the promotion terms outside of the authorization network communication channel. If the flag does not indicate that the customer has received sufficient notice, the transaction is determined to not be eligible for the promotion, and standard terms are applied to the transaction. In various implementations, this check against a threshold time can be performed with other checks from a promotion table, including MCC checks to confirm that the purchase is associated with a category that is eligible for the promotion, that the merchant is eligible for the promotion (e.g. a non-network merchant or any other merchant category identified by promotion data) or any other such promotion eligibility checks.

Step 520 automatically applies the promotion to the transaction at the account number, which can include using the promotion data identified from a promotion table in the authorization system, and generating transaction data by applying the promotion to the transaction with the account number. The transaction data with the promotion applied can then be communicated to additional systems or subsystems which are used to later communicate with the customer involved in the transaction about payments based on the terms of the promotion (e.g. as part of steps 456, 458, or other such steps).

Step 525 then generates an authorization response message. The authorization response message of method 500 authorizes the transaction, as a rejection of the transaction would not involve step 520, since the promotion would be moot if the authorization request is rejected.

Step 530 initiates transmission of the authorization response message authorizing the transaction. Subsequent steps to settle the transaction are performed by other systems, such as merchant system processing the authorization response message and managing network settlement (e.g. in steps 452 and 454) or as part of other channels for communicating with a customer and customer account outside of the authorization network (e.g. steps 456 and 458).

Method 500 as described above thus improves the operation of devices and networks used with promotional transactions by allowing transactions to follow a customer instead of a merchant, and allowing transactions to be applied automatically at authorization without the involvement of merchant systems. Additionally, such promotions can be applied for transactions using restricted authorization networks. Such systems can be used to apply promotions when merchant systems and restriction authorization networks are not configured to accept or manage promotion data.

Additionally, as described above, a payment communication network in accordance with various examples can be configured to perform both method 500 and similar methods, as well as alternative promotional transactions that do involve merchant or network systems. FIG. 6 describes aspects of one implementation of such a system.

In FIG. 6, a customer 622 has an account and associated devices (e.g. a smartphone payment application or a credit card) which is configured for authorizations managed by authorization system 630. The account for customer 622 is associated with a set of network merchant systems 608. Such associations can be for merchants focused on a particular set of merchant types or merchant categories, or any other such collection of merchants. Such associations can be any collection of merchants that register to be associated with account types which include the account of customer 622, which can involve registration with promotion setup system 650 that manages promotions via an authorization system 630. Additional aspects of relationships and interactions between promotion setup system 650 and network merchant systems 608 are described below. Network merchants can manage promotions that follow the merchant, including specific promotion codes that are entered by a merchant as part of a transaction involving customer 622 and a merchant system 608. Such transactions with network merchant systems 608 can use a first network 626 which is configured to handle promotion data for network merchant systems 608 and authorization system 630.

Additionally, the account for customer 622 can be configured for use with non-network merchant systems 618. Configuration for such transactions can use a passthrough restricted authorization network 624. Such a restricted authorization network 624 can handle communications for a purchase that are standardized without promotion data, as described above for FIGS. 2-5. As described above, the promotion setup system 650 for promotions applied to non-network merchant system 618 can provide notification of the promotion terms to customer 622 via a statement system 652 that provides data to customer 622, which can use communication channels to customer devices associated with the account for customer 622, or any other such communication channels. These communication channels allow promotions where system configurations do not allow for communication of promotion data through the authorization network (e.g. passthrough authorization network 624) and merchant systems not configured for promotion data (e.g. non-network merchant systems 618).

In contrast, network merchant systems 608 and network 626 are configured for such promotion data. Such configurations can be set using promotion setup system 650 (e.g. using instructions provided by a networked computer of promotion setup system providing instructions and data to the network merchant systems 608) or via configurations implemented by operations of the network merchant systems 608.

Authorization system 630 can interact with promotion setup system 650 to implement configurations for handling promotions via both network merchant systems 608 and non-network merchant systems 618. Authorization system 630 performs validation and fraud detection as described above using validation system 632 and fraud system 634. Such systems can be used to authorize transactions for the account associated with customer 622 from network and non-network systems. The authorization system 630 can thus accept authorization request messages via both network 626 from network merchant systems 608 and passthrough restricted authorization network 624 from non-network merchant systems 618. While two networks 624 and 626 are described, any number of different networks can be used by different implementations of an authorization system 630. For payment authorization requests received by authorization system 630 from non-network merchant systems 618, promotions can be handled as described above in method 500, for example, by accessing a table in promotion system 636 for network promotions 637 and automatically applying the promotion to the transaction at an account number associated with customer 622 as described above (e.g. in method 500). Promotions for network merchant systems 608 can be handled using different operations and separate promotion data within promotion system 636 from non-network promotions 638.

The use of both network 626 and passthrough restricted authorization network 624 for transactions on a single account associated with customer 622 and authorization system 630 allows for a variety of different promotions using authorization system 630, including different promotion data for different networks. This use of different networks can be considered as different rails for transaction communications. In some implementations, network 626 is a network providing rails associated with the authorization system 630, while passthrough restricted authorization network 624 is a third party network providing rails for a broader set of merchants not connected to network 626. In some systems, restricted authorization networks function as a sub-network on open network rails, and directs data of merchants associated an open network that the sub-network utilizes. This allows open networks to operate with accounts having specific program limitations. The restricted authorization network can also allow a smaller network to allow accounts associated with the smaller network (e.g. network 626) to access additional networks without the smaller network having to duplicate infrastructure available in larger open networks. Embodiments described herein enable smaller systems to implement merchant specific promotions for the networks and merchants directly configured under the control of the smaller system, while allowing different promotion systems implemented in a larger open network, but with the promotions operating independently of the merchants and networks involved with the larger open network.

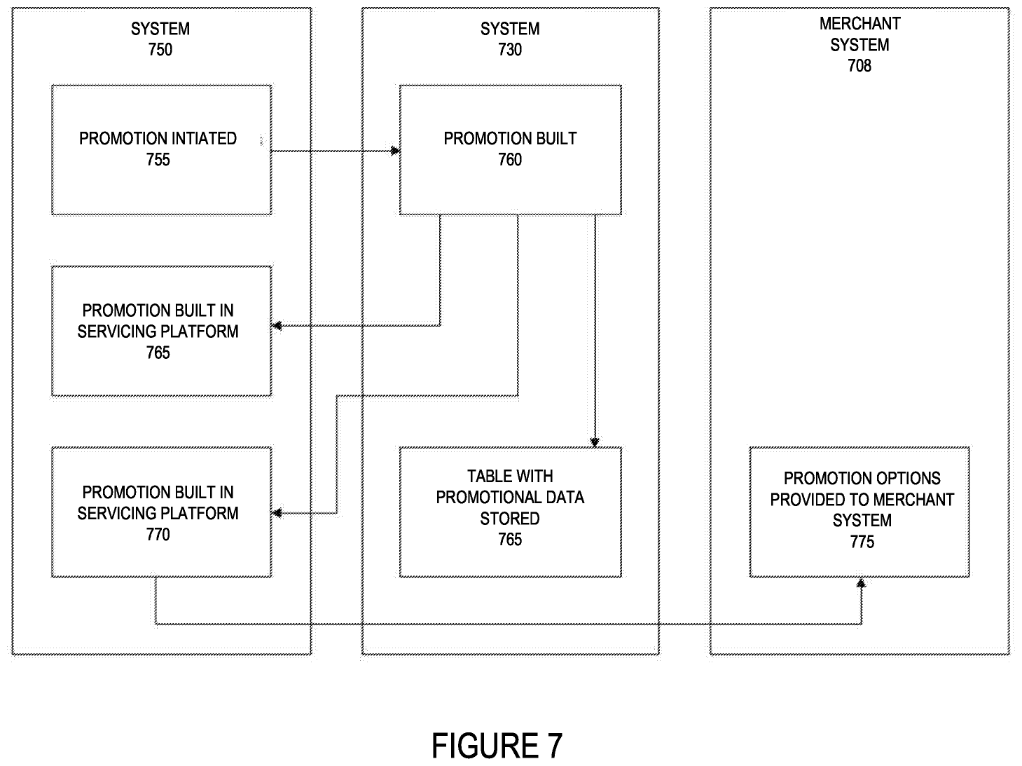

FIG. 7 depicts a system diagram for a first build according to some embodiments. Three entities are depicted: system 750 (e.g. a promotion setup system 650), system 730 (e.g. an authorization system 630), and merchant system 708 (e.g. a network merchant system 608). These entities may be involved in network promotion systems alongside non-network promotion systems as illustrated in FIG. 6. Although shown and described with respect to three entities, it is contemplated that any number of entities may be involved in performing the described steps of FIG. 7.

At step 755, promotions are initiated by sales at the application(s) level as part of system 750. If pricing is needed, the transaction will go to financing. At step 760, the promotions are built onto system 730 (e.g. as part of a mainframe system for the in network configuration and implementation). Once built, the promotions are housed in tables at step 765 and stored at the computing devices of system 730 (e.g. a mainframe or networked devices of an authorization system or other similar system as described herein). At step 765, the servicing platform will be built into the promotions into its system. At step 770, a sales confirmation of the promotional build is generated. At step 775, a menu of allowable promotions and pricing for each is provided to the merchant system 708. Thus, in contrast to the promotions of FIGS. 2-5 where the promotion follows the customer, the promotion of FIG. 7 lives with the merchant system 708, and not the customer.

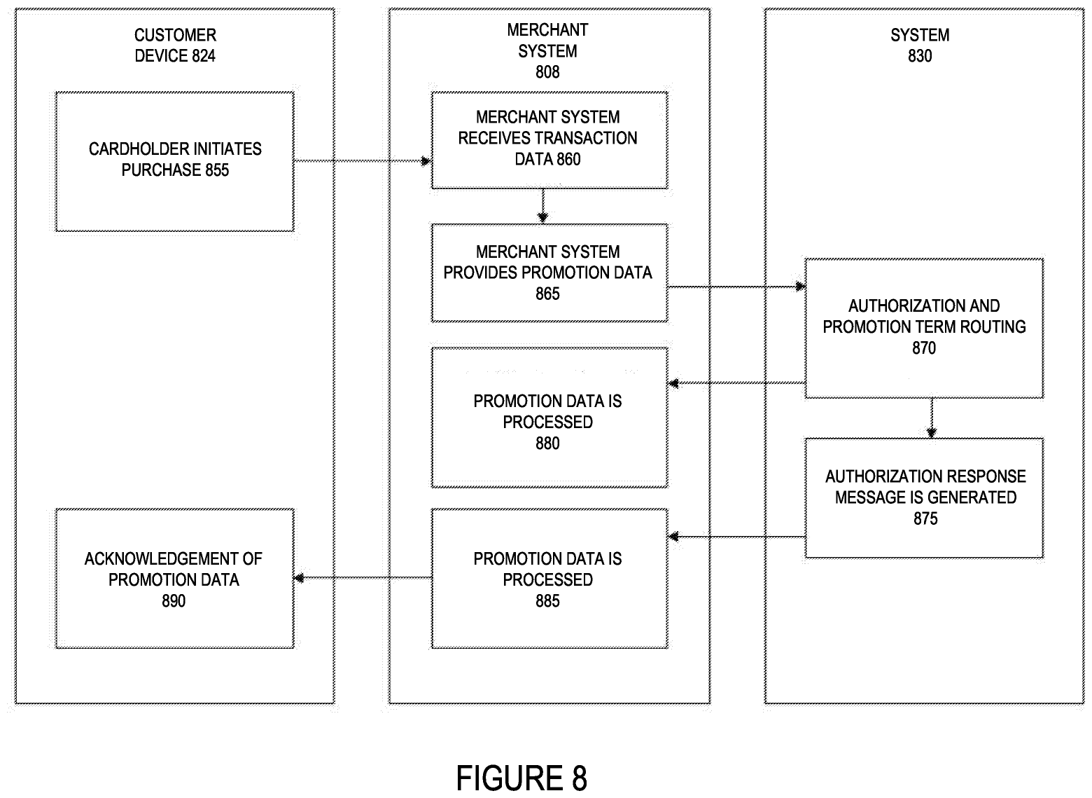

FIG. 8 depicts a system diagram for a first transaction according to some embodiments. Three entities are depicted: customer device 824, merchant system 808, and system 830 (e.g. an authorization system implementing transactions such as authorization system 630). These entities may be involved in executing a transactional promotion process according to some embodiments. Although shown and described with respect to three entities, it is contemplated that any number of entities may be involved in performing the described steps. Although shown and described with different reference numerals, it is contemplated that the entities described herein with the same names may be the same entities.

At step 855, the customer may initiate a purchase using a customer device 824 (e.g. a chip card, smartphone, or other such device associated with the customer's account number). In some embodiments, the purchase may be made at a location or merchant associated with a particular issuer and merchant system 808. At step 860 the merchant system receives transaction date (e.g. via a swipe or entry of the customer account number into a point of sale device). At step 865, the merchant system 808 can provide enter a specific promotional code for the transaction (e.g. from promotion options received in step 775). In some embodiments, multiple promotions may be available. A merchant or vendor representative can select which promotion they want to apply from the allowable promotions in the program, or can offer a selection of promotions to the customer from promotions available and selected as options by the merchant.

At step 870, the transaction may route to the authorization system 830 (e.g. a mainframe) for authorization and promotional term variables. At step 875, the transaction may be authorized by the authorization system 830. At step 885 receipt data or authorization response message data for the customer or transaction can be communication (e.g. provided for display on customer device 824 or printed using a merchant device. The communicated response data may include advanced promotional disclosure language and authorization information which is received and processed in step 880. Communication of such disclosure language can be part of the in network configuration for an in network merchant and a network managed and configured for special promotions as described herein. At step 890, the customer can acknowledge communication of the response message data (e.g. by selecting an input on the customer device 824 or signing a receipt) acknowledging the promotion terms in the promotion data.

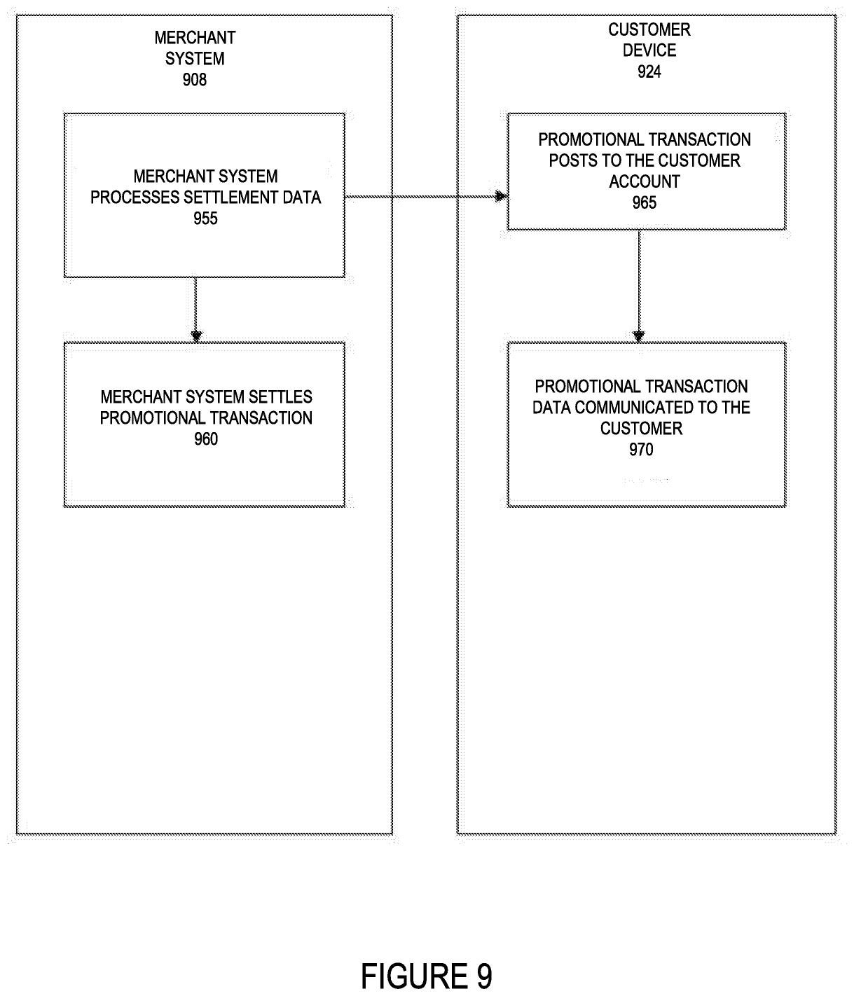

FIG. 9 illustrates a system diagram for a first settlement and statement according to some embodiments. FIG. 9 shows two entities involved in settlement: merchant system 908 and customer device 924. However, any number of additional entities may be involved in the settlement process, such as an issuer system, or other such systems which are not shown.

At step 955, the merchant system 908 processes the settlement data (e.g. a credit card settlement associated with the transaction having the applied promotion as described in FIG. 8). In some implementations, this may occur approximately once per day within merchant system 908. At step 960, settlement occurs for the transaction minus processing fees at the merchant system 908. This may occur within approximately 48 hours of the transaction occurring in some embodiments. At step 965, the promotional purchase may post to the customer account with a specific promotional term (e.g. using a statement system such as statement system 652). At step 970, the promotional purchase appears to the customer statement.

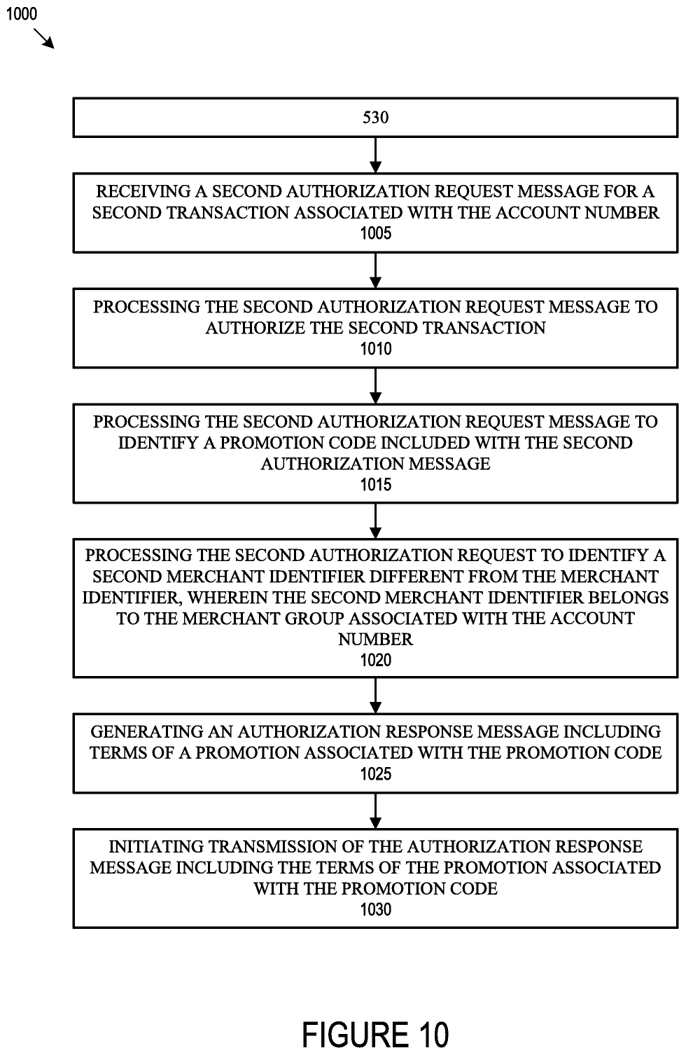

FIG. 10 is a flow diagram illustrating an example method 1000 in accordance with some embodiments. Method 1000 can be performed by one or more processors of a server computer or server system as part of an authorization system (e.g. authorization systems 130, 230, 330, etc.). Method 1000 can, in some examples, be implemented as computer readable instructions that, when executed by processing circuitry of a device, cause the device to perform steps of method 1000. The operations of method 1000 are performed in a system that also performs method 500. The operations of method 1000 can be integrated in various ways with the operations of method 500, and can occur repeatedly in various orders, depending on the merchants visited by the customer associated with an account number. Additionally, while methods 500 and 1000 describe operations for a single customer and account number, these operations can be performed by an authorization system (e.g. a mainframe system) for any number of customers and associated accounts. Additionally promotional programs for different sets of network affiliations for different groups of merchants, different promotional programs, or any other such variations, can be implemented within a system as described herein. An authorization system can thus include devices implementing methods 500 and 1000 for different customers, different in network merchant groupings, different non-network merchant groupings, different communication rails, and other such variations of a system, in accordance with the examples described herein.

Step 1005 of method 1000 includes receipt of a second authorization request message for a second transaction associated with the account number. As illustrated, this follows operation of step 530, but as discussed above, such steps can be integrated in a repeated fashion in a system as described herein, including various intervening steps and steps for additional parties.

Step 1010 the processes the second authorization request message to authorize the second transaction.

Step 1015 processes the second authorization request message to identify a promotion code included with the second authorization message.

Step 1020 processes the second authorization request to identify a second merchant identifier different from the merchant identifier, where the second merchant identifier belongs to the merchant group associated with the account number.

Step 1025 generates an authorization response message including terms of a promotion associated with the promotion code.

Step 1030 initiates transmission of the authorization response message including the terms of the promotion associated with the promotion code.

These steps can then be repeated or performed with the steps of method 500 as the customer initiates transactions with combinations of in network merchants for method 1000 and out of network merchants for method 500.

FIG. 11 illustrates a computing system architecture 1100 including various components in electrical communication with each other using a connection 1106, such as a bus, in accordance with some implementations. Example system architecture 1100 includes a processing unit (CPU or processor) 1104 and a system connection 1106 that couples various system components including the system memory 1120, such as ROM 1118 and RAM 1116, to the processor 1104. The system architecture 1100 can include a cache 1102 of high-speed memory connected directly with, in close proximity to, or integrated as part of the processor 1104. The system architecture 1100 can copy data from the memory 1120 and/or the storage device 1108 to the cache 1102 for quick access by the processor 1104. In this way, the cache can provide a performance boost that avoids processor 1104 delays while waiting for data. These and other modules can control or be configured to control the processor 1104 to perform various actions.

Other system memory 1120 may be available for use as well. The memory 1120 can include multiple different types of memory with different performance characteristics. The processor 1104 can include any general purpose processor and a hardware or software service, such as service 1 1110, service 2 1112, and service 3 1114 stored in storage device 1108, configured to control the processor 1104 as well as a special-purpose processor where software instructions are incorporated into the actual processor design. The processor 1104 may be a completely self-contained computing system, containing multiple cores or processors, a bus, memory controller, cache, etc. A multi-core processor may be symmetric or asymmetric.

To enable user interaction with the computing system architecture 1100, an input device 1122 can represent any number of input mechanisms, such as a microphone for speech, a touch-sensitive screen for gesture or graphical input, keyboard, mouse, motion input, speech and so forth. An output device 1124 can also be one or more of a number of output mechanisms known to those of skill in the art. In some instances, multimodal systems can enable a user to provide multiple types of input to communicate with the computing system architecture 1100. The communications interface 1126 can generally govern and manage the user input and system output. There is no restriction on operating on any particular hardware arrangement and therefore the basic features here may easily be substituted for improved hardware or firmware arrangements as they are developed.

Storage device 1108 is a non-volatile memory and can be a hard disk or other types of computer readable media which can store data that are accessible by a computer, such as magnetic cassettes, flash memory cards, solid state memory devices, digital versatile disks, cartridges, RAMs 1116, ROM 1118, and hybrids thereof.

The storage device 1108 can include services 1110, 1112, 1114 for controlling the processor 1104. Other hardware or software modules are contemplated. The storage device 1108 can be connected to the system connection 1106. In one aspect, a hardware module that performs a particular function can include the software component stored in a computer-readable medium in connection with the necessary hardware components, such as the processor 1104, connection 1106, output device 1124, and so forth, to carry out the function.

The disclosed gift selection, attribution, and distribution system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couples the processor to the network interface device. The interface can include one or more of a modem or network interface. It will be appreciated that a modem or network interface can be considered to be part of the computer system. The interface can include an analog modem, Integrated Services Digital network (ISDNO modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included (e.g. in FIG. 5 or 10). A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving an authorization request message for a transaction associated with an account number, wherein the authorization request message includes a merchant category code;
processing the authorization request message to authorize the transaction;
processing the authorization request message to determine that the transaction is eligible for a promotion based on the merchant category code;
automatically applying the promotion to the transaction at the account number;
generating an authorization response message; and
initiating transmission of the authorization response message authorizing the transaction.

2. The computer-implemented method of claim 1, wherein processing the authorization request message to determine that the transaction is eligible for the promotion includes identifying one or more transaction values from the authorization request message;
wherein the one or more transaction values follow a customer associated with the authorization request; and
wherein the transaction is further determined as eligible based on the one or more transaction values.

3. The computer-implemented method of claim 2, wherein the one or more transaction values include a purchase amount.

4. The computer-implemented method of claim 3, wherein the one or more transaction values further include a vendor network indicator.

5. The computer-implemented method of claim 4, wherein processing the authorization request message to determine that the transaction is eligible for the promotion includes:
accessing a promotion table;
identifying an associated entry in the promotional table associated with the purchase amount and the merchant category code; and
identifying the promotion from the associated entry in the promotion table.

6. The computer-implemented method of claim 1, wherein the authorization request message does not include promotion information.

7. The computer-implemented method of claim 1, wherein processing the authorization request message to authorize the transaction includes:
processing a merchant identifier and the account number from the authorization request message;
analyzing one or more transaction values associated with the authorization request message using a set of fraud rules; and
authorizing the transaction based on the set of fraud rules, the merchant identifier, and the account number.

8. The computer-implemented method of claim 7, wherein the transaction is further determined as eligible for the promotion based on the merchant identifier not belonging to a merchant group associated with the account number.

9. The computer-implemented method of claim 8 further comprising:
receiving a second authorization request message for a second transaction associated with the account number;
processing the second authorization request message to authorize the second transaction;
processing the second authorization request message to identify a promotion code included with the second authorization message;
processing the second authorization request to identify a second merchant identifier different from the merchant identifier, wherein the second merchant identifier belongs to the merchant group associated with the account number;
generating an authorization response message including terms of a promotion associated with the promotion code; and initiating transmission of the authorization response message including the terms of the promotion associated with the promotion code.

10. A system comprising:
a memory storing a authorization request message received for a transaction associated with an account number, wherein the authorization request message includes a merchant category code; and
one or more processors coupled to the memory and configured to perform operations comprising:
processing the authorization request message to authorize the transaction;
processing the authorization request message to determine that the transaction is eligible for a promotion based on the merchant category code;
automatically applying the promotion to the transaction at the account number;
generating an authorization response message; and
initiating transmission of the authorization response message authorizing the transaction.

11. The system of claim 10, wherein processing the authorization request message to determine that the transaction is eligible for the promotion includes identifying one or more transaction values from the authorization request message;
wherein the one or more transaction values follow a customer associated with the authorization request; and
wherein the transaction is further determined as eligible based on the one or more transaction values.

12. The system of claim 11, wherein the one or more transaction values include a purchase amount.

13. The system of claim 12, wherein the one or more transaction values further include a vendor network indicator.

14. The system of claim 13, wherein processing the authorization request message to determine that the transaction is eligible for the promotion includes:
accessing a promotion table;
identifying an associated entry in the promotional table associated with the purchase amount and the merchant category code; and
identifying the promotion from the associated entry in the promotion table.

15. The system of claim 10, wherein the authorization request message does not include promotion information.

16. The system of claim 10, wherein the one or more processors are further configured for operations comprising:
receiving a second authorization request message for a second transaction associated with the account number;
processing the second authorization request message to authorize the second transaction;
processing the second authorization request message to identify a promotion code included with the second authorization message;
processing the second authorization request to identify a second merchant identifier different from the merchant identifier, wherein the second merchant identifier belongs to the merchant group associated with the account number;
generating an authorization response message including terms of a promotion associated with the promotion code; and
initiating transmission of the authorization response message including the terms of the promotion associated with the promotion code.

17. A non-transitory computer readable storage medium comprising instructions that, when executed by one or more processors of a device, cause the device to perform operations comprising:
receiving an authorization request message for a transaction associated with an account number, wherein the authorization request message includes a merchant category code;
processing the authorization request message to authorize the transaction;
processing the authorization request message to determine that the transaction is eligible for a promotion based on the merchant category code;
automatically applying the promotion to the transaction at the account number;
generating an authorization response message; and
initiating transmission of the authorization response message authorizing the transaction.

18. The non-transitory computer readable storage medium of claim 17, wherein processing the authorization request message to determine that the transaction is eligible for the promotion includes identifying one or more transaction values from the authorization request message;
wherein the one or more transaction values follow a customer associated with the authorization request;
wherein the transaction is further determined as eligible based on the one or more transaction values;
wherein the one or more transaction values include a purchase amount;
wherein the one or more transaction values further include a vendor network indicator; and
wherein processing the authorization request message to determine that the transaction is eligible for the promotion includes:
accessing a promotion table;
identifying an associated entry in the promotional table associated with the purchase amount and the merchant category code; and
identifying the promotion from the associated entry in the promotion table.

19. The non-transitory computer readable storage medium of claim 17, wherein the authorization request message does not include promotion information.

20. The non-transitory computer readable storage medium of claim 17, wherein the instructions further cause the device to perform operations comprising:
receiving a second authorization request message for a second transaction associated with the account number;
processing the second authorization request message to authorize the second transaction;
processing the second authorization request message to identify a promotion code included with the second authorization message;
processing the second authorization request to identify a second merchant identifier different from the merchant identifier, wherein the second merchant identifier belongs to the merchant group associated with the account number;
generating an authorization response message including terms of a promotion associated with the promotion code; and
initiating transmission of the authorization response message including the terms of the promotion associated with the promotion code.
